(19) United States
(12) Patent Application Publication
(10) Pub. No.: US 2006/0254377 A1
(43) Pub. Date: Nov. 16, 2006

(54) Device for controlling a vehicle

(76) Inventor: Jorg Henle, Deubach (DE)

Correspondence Address: BACHMAN & LAPOINTE, P.C., 900 CHAPEL STREET, SUITE 1201, NEW HAVEN, CT, 06510, US

(21) Appl. No.: 10/544,892

(22) PCT Filed: Nov. 27, 2003
(86) PCT No.: PCT/EP03/13361

§ 371 Date: May 2, 2006

(30) Foreign Application Priority Data
Feb. 7, 2003 (DE) 103 05 261.5

(51) Int. Cl. G05G 9/047

(52) U.S. Cl. 74/471 XY

(57) ABSTRACT

A device for controlling a vehicle, especially an aircraft, helicopter, or simulator, comprising a handle which is mounted so as to be movable about two axes (A, B) that are located approximately perpendicular to each other. The axes (A, B) are located on different planes (E₁ and E₂ or E₁ and E₃) and are offset relative to each other.

The present invention relates to an apparatus for controlling a vehicle, in particular an aircraft, helicopter or else a simulator, having a handle which is mounted such that it can move about two approximately mutually perpendicular axes.

Apparatuses such as these are known and are commercially available on the market in many forms and versions. They are essentially used for controlling aircraft, helicopters, flight simulators or the like. In this case, a handle can be pivoted essentially about two axes in order, for example, to control a helicopter, in particular its rotor.

Conventional apparatuses have the disadvantage that they are large, complex and costly, in particular with different linkages. In this case, complicated levers and deflection systems are required in order to produce two different movable axes for helicopter control, in order, for example, to drive the rotor. Procurement of these apparatuses is thus expensive, and they are costly to maintain.

The present invention is based on the object of providing an apparatus of the type mentioned initially, which overcomes the stated disadvantages and by means of which an apparatus for exact control of vehicles, aircraft, helicopters and simulators is possible in a simple and cost-effective manner, and which also allows active force feedback to the handle. In this case, the aim is to allow this apparatus to be accommodated well in confined installation spaces. A further aim is to improve the safety during operation.

The features of patent claims 1 and 2 lead to the achievement of this object.

In the case of the present invention, it is important that an apparatus is provided which is formed from a frame element with adjacent baseplates on each side. A baseplate is connected to a drive element, which is fitted with a force sensor, via a holding element, such that it can pivot about a first axis and allows a pivoting movement about this first axis, possibly by means of force feedback.

In order to move the handle about a further axis at right angles to this, a further drive element is connected to a baseplate of the frame element, and is preferably firmly connected to the structure of the vehicle, helicopter or simulator.

In one preferred exemplary embodiment, the two axes which are at right angles to one another are on different parallel planes, and are offset with respect to one another.

This ensures that different movement options and pivoting mechanisms of the handle are provided, which is particularly important for actuation of helicopter rotors.

In this case, one aim is to ensure that the one axis is offset upwards or downwards with respect to the other axis. This makes it possible to produce different pivoting movements about the first axis or about the second axis by pivoting the axes to different extents. In addition, a force acting on the handle can be measured via the force sensor, and allows force feedback via the drive elements. This is likewise intended to be within the scope of the present invention.

Further advantages, features and details of the invention will become evident from the following description of preferred exemplary embodiments, in which:

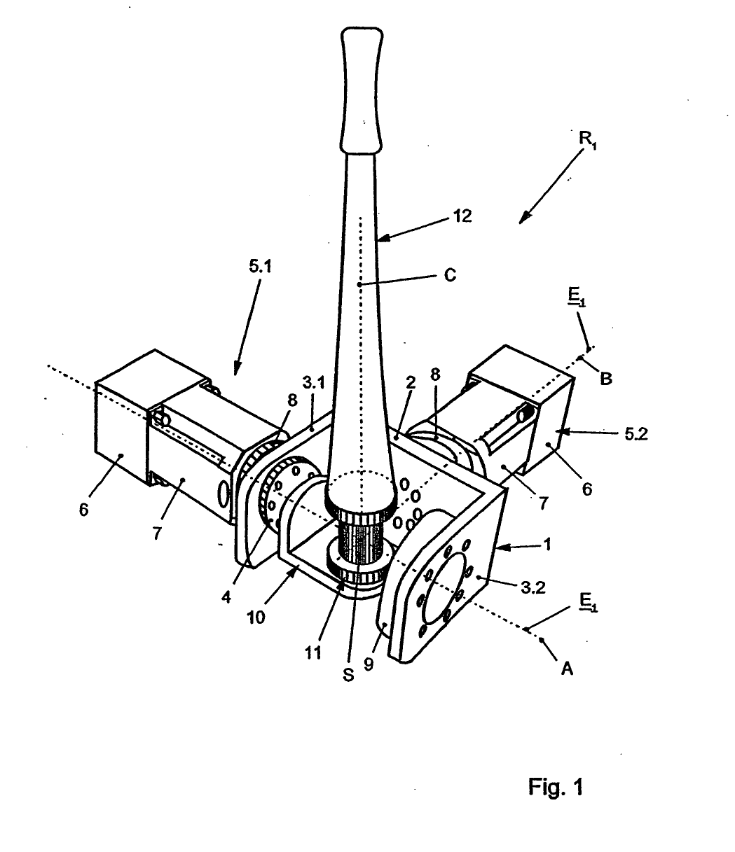

FIG. 1 shows a perspective illustration of an apparatus according to the invention for controlling a vehicle, in particular an aircraft;

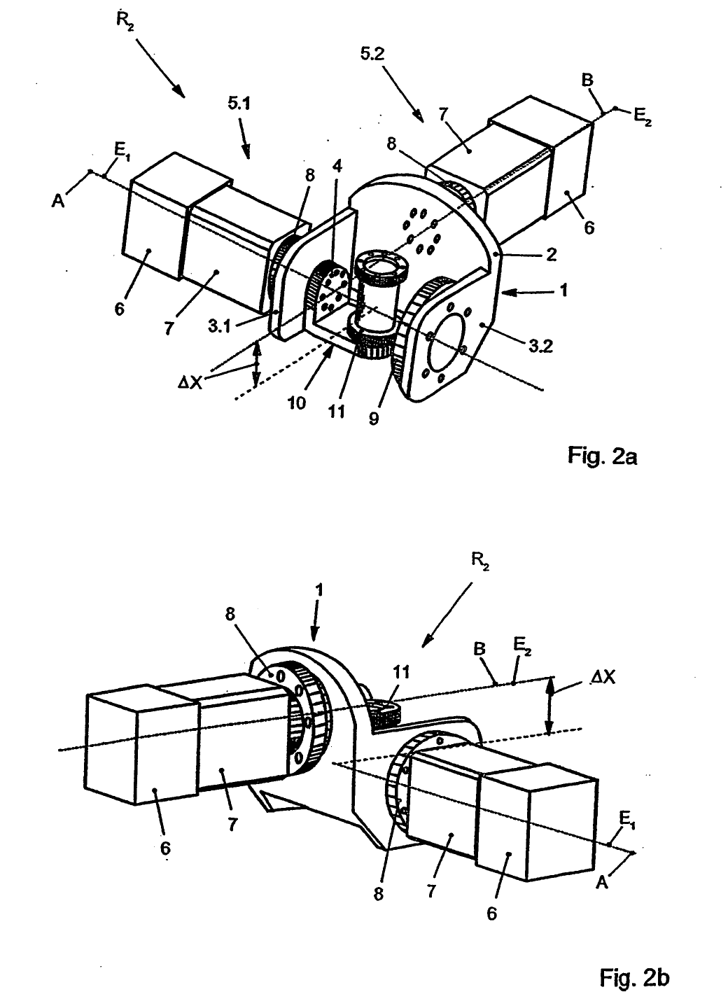

FIG. 2a shows a perspective plan view of one preferred exemplary embodiment of the apparatus for controlling an aircraft as shown in FIG. 1;

FIG. 2b shows a perspective rear view of the apparatus as shown in FIG. 2a;

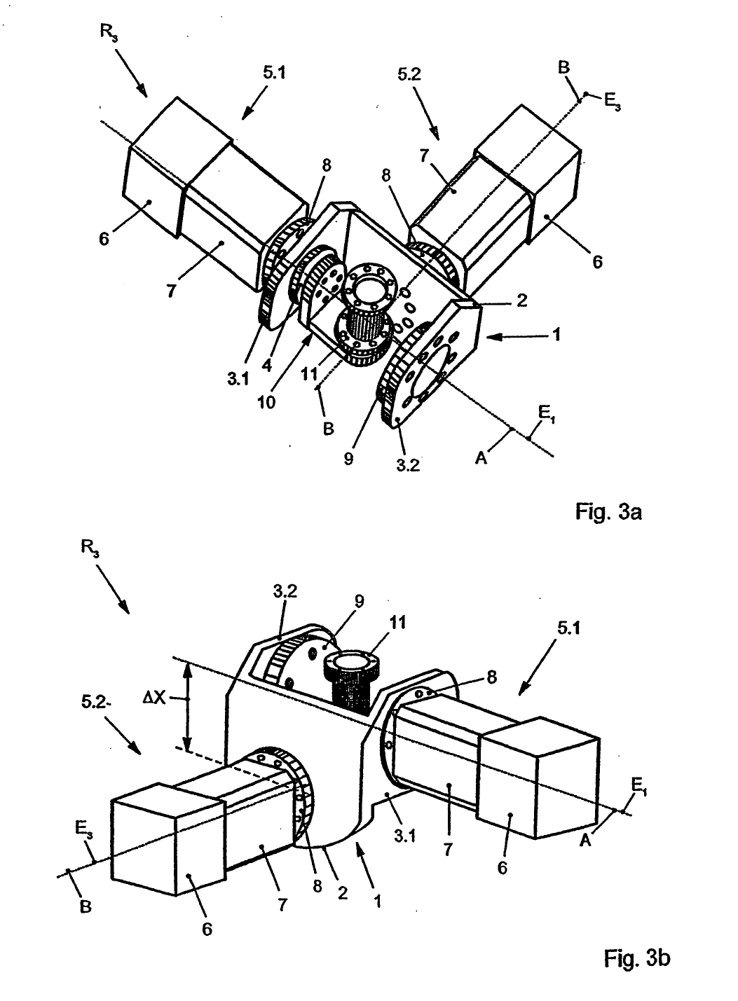

FIG. 3a shows a perspective plan view of yet another exemplary embodiment of the apparatus as shown in FIG. 1; and

FIG. 3b shows a schematically illustrated rear view of the apparatus as shown in FIG. 3a.

As seen in FIG. 1, an apparatus R₁ according to the invention has a frame element 1 for controlling vehicles or simulators, in particular aircraft simulators, which frame element 1 is preferably formed from a baseplate 2 and holding plates 3.1, 3.2 which are adjacent on each side and are at right angles to the baseplate 2.

A first drive element 5.1 is connected on the outside to the frame element 1, in particular to the holding plate 3.1, via an output flange 4. In this case, the drive element 5.1 lies on an axis A which is at right angles to the holding plate 3.1.

A further drive element 5.2 is connected on the outside to the baseplate 2 of the frame element and is firmly connected to a structure, a holder or the like of the simulator or vehicle, although this is not illustrated here.

The drive element 5.2 is arranged on an axis B which runs approximately at right angles to the baseplate 2. In this exemplary embodiment, the axes A and B intersect at an intersection point S on a common plane E_{1.}

The drive elements 5.1, 5.2 are essentially formed from an electronic control device 6 and an electric motor 7 which is connected to it and has a transmission 8 on the output side. In this case, the electronic control device 6 may contain force control, motor control, etc.

A balance weight 9 is connected to the holding plate 3.2, and its center of gravity is located on the axis A. The balance weight 9 is used for mass balancing of the drive element 5.1, which can be pivoted together with the frame element 1 about the axis B by means of the drive element 5.2.

A holding element 10 is connected to the drive element 5.1, adjacent to the output flange 4, and can be pivoted about the axis A by means of the drive element 5.1. The holding element 10 is preferably in the form of a bracket, to which a force sensor 11 is connected. This likewise allows the position of the force sensor to be influenced.

The force sensor 11, whose axis C runs at right angles through the intersection point S of the axes A and B, is used to hold a handle 12, which is actively controllable or is mounted such that it can be pivoted by means of the human hand about the axes A and B. In this case, the drive elements 5.1, 5.2 provide force feedback, for active control. The force sensor 11 can receive the appropriate resetting moments and can appropriately control them or compensate for them via the drive elements 5.1, 5.2.

In a further preferred exemplary embodiment of the present invention as shown in FIG. 2a, FIG. 2a shows an apparatus R₂ which corresponds approximately to the apparatus mentioned above.

One significant difference in this case is that the drive element 5.2 and its axis B are offset by a distance ΔX with respect to the axis A of the drive element 5.1. The axes A and B are at right angles to one another, but are offset with respect to one another by the distance ΔX on different planes E₁, E₂, which are parallel to one another.

This ensures that different movement capabilities of the handle 12, which is not illustrated here, about the axis A or B are possible.

The corresponding rear view once again shows the corresponding movement of the axes A and B with respect to one another.

In this case, the axis B is located above the axis A, with the baseplate 1 of the frame element 1 overhanging the holding plates 3.1, 3.2 at the end in this area, preferably in a slightly curved manner.

In the exemplary embodiment of the present invention as shown in FIGS. 3a and 3b, FIGS. 3a and 3b show an apparatus R₃ which corresponds approximately to the type described above.

The difference here is that the axis B is offset by the distance ΔX, in the manner described above, below the axis A. In this case, the axes A and B are likewise at right angles to one another, and lie on different planes E₁, E₂ which are parallel to one another.

This likewise ensures that the handle 12, which is connected to the force sensor 11, carries out different movements about the axes A and B. This makes it possible to influence different installation spaces, if the axis A is located above the axis B, or vice versa.

It is also possible for the different axes A and B or rotation axes to additionally ensure that the height of the force sensor 11 and of the handle 12 can be adjusted.

List of item numbers

| | |
|---|---|
| 1 | Frame element |
| 2 | Baseplate |
| 3 | Holding plate |
| 4 | Output flange |
| 5 | Drive element |
| 6 | Control device |
| 7 | Electric motor |
| 8 | Transmission |
| 9 | Balance weight |
| 10 | Holding element |
| 11 | Force sensor |
| 12 | Handle |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| R₁ | Apparatus |
| R₂ | Apparatus |
| R₃ | Apparatus |
| ΔX | Distance |
| A | Axis |
| B | Axis |
| C | Axis |
| E₁ | Plane |
| E₂ | Plane |
| E₃ | Plane |
| S | Intersection |

1-18. (canceled)

19. An apparatus for controlling a vehicle comprising a handle (12) which is mounted for movement about two substantially perpendicular axes (A, B), wherein the axes (A, B) are located on different planes (E₁ and E₂ or E₁ and E₃) and are offset with respect to one another.

20. An apparatus for controlling a vehicle comprising a handle (12) which is mounted for movement about two substantially perpendicular axes (A, B), holding means (10) for holding a force sensor (11) is provided on an axis (A) wherein the force sensor is arranged centrically or eccentrically, and offset vertically upwards or downwards with respect to the axis (A).

21. The apparatus as claimed in claim 20, wherein a frame element (12) is provided with two drive elements (5.1, 5.2) which act at substantially right angles to one another.

22. The apparatus as claimed in claim 21, wherein the frame element (1) comprises a baseplate (2) having at least one holding plate (3.1, 3.2) which is connected to the baseplate at right angles.

23. The apparatus as claimed in claim 21, wherein the frame element (1) comprises a U-shape baseplate (2) having holding plates (3.1, 3.2) which are adjacent at the side and at right angles to the baseplate.

24. The apparatus as claimed in claim 21, wherein a first drive element (5.1) is connected to the baseplate (2), and a second drive element (5.2) being fixed to the baseplate (2), and the holding means (10) for holding the force sensor (11) is arranged within the baseplate (2) such that it can pivot about the axis (A).

25. The apparatus as claimed in claim 24, wherein the second drive element (5.2) is connected to the baseplate (2) and is approximately at right angles to the first drive element (5.1).

26. The apparatus as claimed in claim 21, wherein the drive elements (5.1, 5.2) are connected to the frame element (1) at right angles to one another on the axes (A, B), wherein the axes (A and B) are offset with respect to one another by a distance (ΔX).

27. The apparatus as claimed in claim 21, wherein the drive elements (5.1, 5.2) are formed from an electronic control device (6) with integrated force control and motor control, an adjacent electric motor (7) and a downstream transmission (8).

28. The apparatus as claimed in claim 21, wherein the holding means (10) is connected to a first drive element (5.1) via an output flange (4), on which holding means (10), the force sensor (11) and a handle (12) are seated wherein the handle is connected to the force sensor.

29. The apparatus as claimed in claim 28, wherein the holding means (10) comprises a plate which is pivotable about the axis (A) and is fitted with the force sensor (11).

30. The apparatus as claimed in claim 22, wherein a second holding plate (3.2) is connected to the baseplate (2) and a balance weight (9), whose center of gravity lies on the axis (A) is held on the second holding plate.

31. The apparatus as claimed in claim 29, wherein the handle (12) is pivotable about the axes (A and B) by means of the drive elements (5.1, 5.2).

32. The apparatus as claimed in claim 31, wherein the drive elements (5.1, 5.2) and the force sensor (11) allow force feedback, ensuring active control of the handle (12).

33. The apparatus as claimed in claim 24, wherein the second drive element (5.2) is firmly fixed on a vehicle.

34. The apparatus as claimed in claim 26, wherein the axis (B) is offset the distance (ΔX) above the axis (A).

35. The apparatus as claimed in claim 26, wherein the axis (B) is offset the distance (ΔX) below the axis (A).

36. The apparatus as claimed in claim 20, wherein the axes (A and B) run at right angles to one another and are located on different planes (E₁ and E₂ or E₁ and E₃), wherein the planes are parallel to one another.
